(19) United States
(12) Patent Application Publication
(10) Pub. No.: US 2012/0155697 A1
(43) Pub. Date: Jun. 21, 2012

(54) ELECTROMAGNETIC TRANSDUCER

(75) Inventors: Lin Liu, Shenzhen (CN); Xu-Dong Yan, Shenzhen (CN)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/332,346

(22) Filed: Dec. 20, 2011

(30) Foreign Application Priority Data
Dec. 21, 2010 (CN) 201020671916.7
Dec. 29, 2010 (CN) 201020686785.X

(51) Int. Cl. H04R 1/00

(52) U.S. Cl. 381/412

(57) ABSTRACT

An electromagnetic transducer includes a frame, a diaphragm including a top plate and a periphery portion surrounding the top portion and attached to the frame, a magnetic circuit part receiving in the frame with a magnetic gap, a voice coil partially inserted into the magnetic gap for driving the diaphragm, and an elastic member including a first arm attached to the diaphragm and disposed in a plane and a pair of second arms extending outwards from the first arm and attached to the frame. The second arm further defines a stress-releasing portion protruding outwards from the plane where the first arm is disposed in.

### FIELD OF THE INVENTION

The present disclosure relates to an electromagnetic transducer, and more particularly to an electromagnetic transducer with an elastic member.

### DESCRIPTION OF RELATED ART

As the science-technology and society advance with high speed, greater use of the electronic devices boosts the quick development of electromagnetic transducers. Multiple functions and long life of electromagnetic transducers are required for people enjoying the technical sense of both vision and ear.

A related electromagnetic transducer mounted to a television includes a vibrating unit and an elastic member with a number of elastic arms for supporting the vibrating unit. When the vibrating unit is vibrating, the root of the elastic arm generally suffers greater stress than other parts thereof. And long time of vibration of the elastic arm results in mechanical fatigue, which easily causes the root broken up.

Therefore, it is necessary to provide a new electromagnetic transducer for solving the problems mentioned above.

### BRIEF DESCRIPTION OF THE DRAWINGS

FIG. 1 is an isometric exploded view of an electromagnetic transducer in accordance with an exemplary embodiment of the present disclosure;

FIG. 2 is an isometric assembled view of the electromagnetic transducer shown in FIG. 1;

FIG. 3 is a partially assembled view shown in FIG. 2, with a periphery portion of a diaphragm of the electromagnetic transducer separated from other parts;

FIG. 4 is an isometric view of an elastic member of the electromagnetic transducer in accordance with an exemplary embodiment of the present disclosure shown in FIG. 1;

FIG. 5 is an enlarged view of part V shown in FIG. 1;

FIG. 6 is a cross-sectional view of the electromagnetic transducer taken along line VI-VI in FIG. 2;

FIG. 7 is an isometric view of an elastic member of the electromagnetic transducer in accordance with another exemplary embodiment of the present disclosure.

### DETAILED DESCRIPTION OF THE EMBODIMENTS

Reference will now be made to describe the exemplary embodiments of the present disclosure in detail.

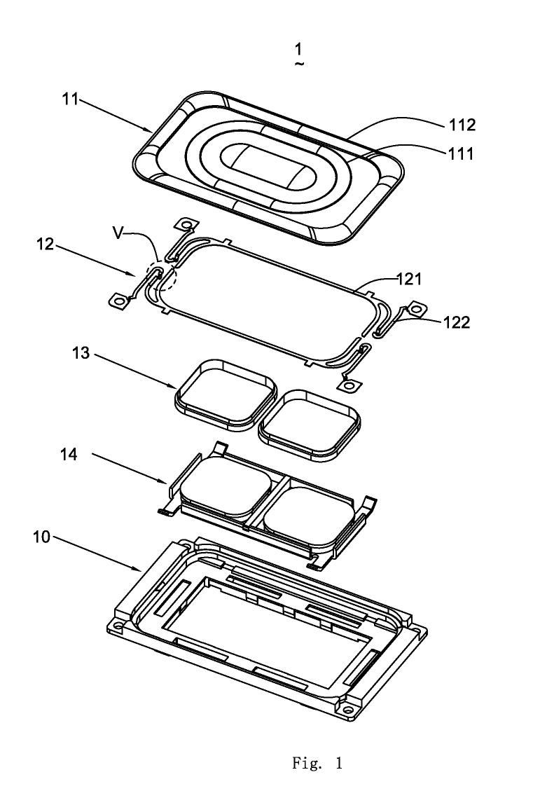

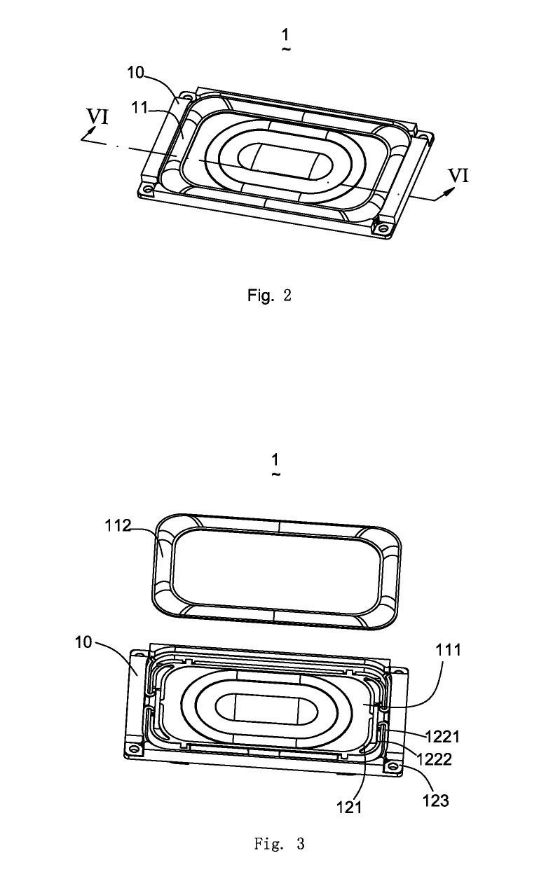

Referring to FIGS. 1 and 2, an electromagnetic transducer 1 comprises a frame 10, a diaphragm 11 assembled with the frame 10, a pair of elastic members 12 assembled with the frame and connected with the diaphragm 11, a magnetic circuit part 14 receiving in the frame 10 and defining a pair of magnetic gaps, and a pair of voice coils 13 each defining one end partially inserted into the magnetic gap for driving the diaphragm 11. The combination of the diaphragm 11 and the voice coils 13 serves as a vibrating unit. The diaphragm 11 includes a top plate 111 and a periphery portion 112 surrounding the top plate 111 and defines an outer fringe attached to the frame 10 and an inner fringe connected with the top plate 111.

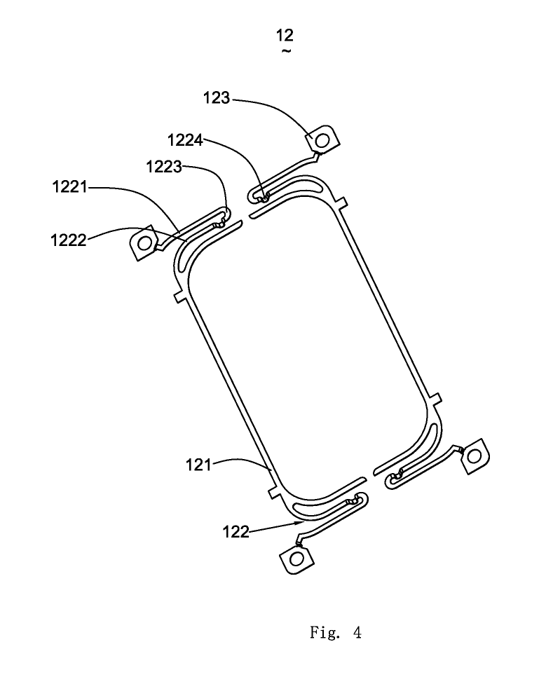

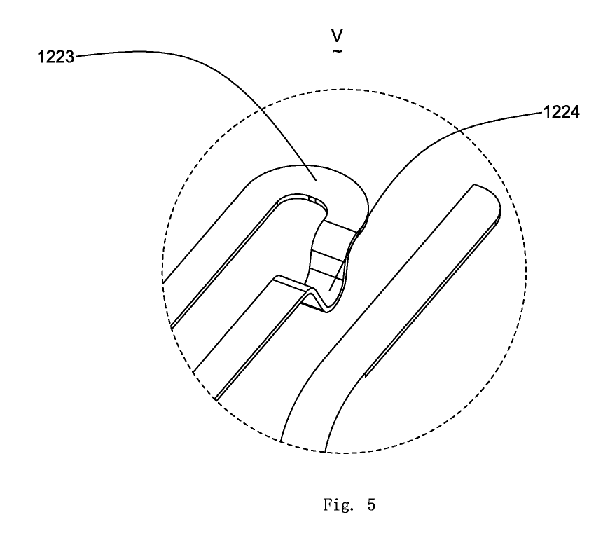

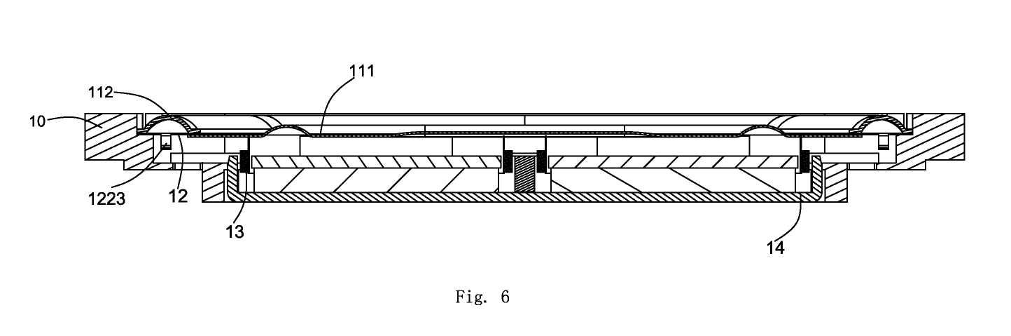

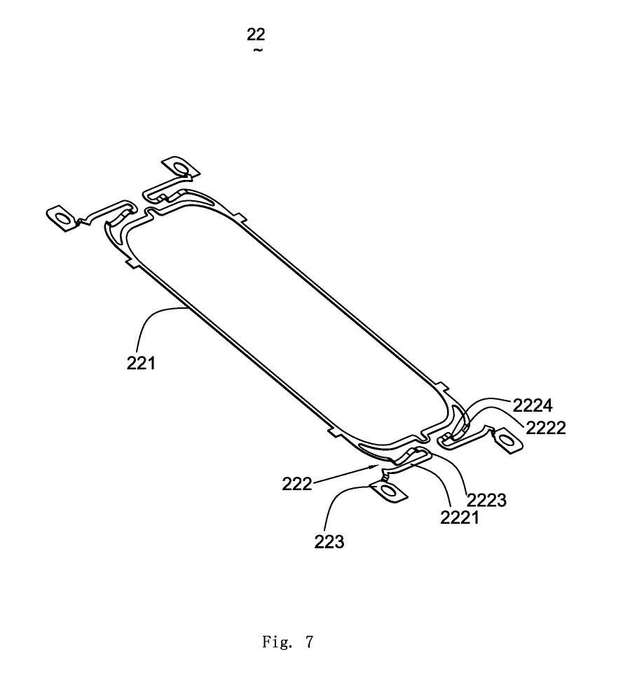

Referring to FIGS. 3-6, an elastic member 12 in accordance with an exemplary embodiment of the present disclosure defines a U-shaped first arm 121 attached on the top plate 111 of the diaphragm 11, a pair of second arm 122 respectively extending outwards from the two angles of the U-shaped first arm 121 along a devious way, and a pair of position plates 123 disposed at the end of the second arms 121 and each defining a hole. The first arm 121 is disposed between the inner fringe of the periphery portion 112 and the top plate 111 of the diaphragm 11. Therefore, the first arm 121 could vibrate along with the vibrating unit. The second arm 122 defines a first part 1221 attached to the frame 10, a second part 1222 connected with the first arm 121 and a U-shaped root part 1223 connected the first part 1221 and the second part 1222. The first part 1221 is disposed between the outer fringe of the periphery portion 112 and the frame 10. The second part 1222 is adjacent to the first arm 121 and forms a slit therebetween. The second part 1222 defines a U-shaped stress-relieving portion 1224 adjacent to the root part 1223 and protrudes along a vibrating direction of the vibrating unit away from the diaphragm 11. In other embodiment, the pair of elastic members 12 could be integrated by connecting the U-shaped first arms 121 thereof (just like the configuration shown in FIG. 7).

When the diaphragm 11 is driven to vibrate by the voice coils, the first arm 121 drives the second part 1222 of the second arm 122 vibrating and results in that the root part 1223 of the second arm 122 suffers greatest stress. But the U-shaped stress-relieving portion 1224 could enhance the flexibility of the second part 1222 and share the stress with the root part 1223 so that the root part 1223 is not easy to be broken.

Referring to FIG. 7, an elastic member 22 in accordance with another exemplary embodiment of the present disclosure defines a pair of U-shaped first arm 221 integrated with each other and disposed in a plane, four second arms 222 respectively extending outwards from angles of the U-shaped first arms 221 along a devious way, and four position plates 223 disposed at the end of the second arms 221 and each defining a hole. Each second arm 222 defines a first part 2221 attached to the frame 10, a second part 2222 connected with the first arm 221 and a U-shaped root part 2223 disposed between the first part 2221 and the second part 2222. The second part 2222 is adjacent to the first arm 221 and forms a slit therebetween. The second part 1222 further defines an undulate-shaped stress-relieving portion 2224 adjacent to the root part 1223 and protrudes outwards from the plane of the first arm 221 disposed in. The a undulate-shaped stress-relieving portion 2224 could enhance the flexibility of the second part 2222 and share the stress with the root part 2223 so that the root part 2223 is not easy to be broken.

In other embodiment, the pair of U-shaped first arm 221 could be separated, and the shape of the stress-relieving portion 1224,2224 is not limited or restricted to the configuration shown in the figures, and the amount of the stress-relieving portions could be two or more.

While the present disclosure has been described with reference to the specific embodiments, the description of the disclosure is illustrative and is not to be construed as limiting the disclosure. Various of modifications to the present disclosure can be made to the exemplary embodiments by those skilled in the art without departing from the true spirit and scope of the disclosure as defined by the appended claims.

What is claimed is:

1. An electromagnetic transducer, comprising:
a frame;
a diaphragm including a top plate, and a periphery portion surrounding the top portion and attached to the frame;
a magnetic circuit part receiving in the frame and defining a magnetic gap;
a voice coil partially inserted into the magnetic gap for driving the diaphragm;
an elastic member including a first arm disposed in a plane and attached to the diaphragm, a second arm extending outwards from the first arm and attached to the frame; wherein
the second arm defining a stress-releasing portion protruding outwards from the plane where the first arm is disposed in.

2. The electromagnetic transducer as described in claim 1, wherein the stress-releasing portion is U-shaped and protrudes along a vibrating direction of the vibrating unit away from the diaphragm.

3. The electromagnetic transducer as described in claim 1, wherein the stress-relieving portion is undulate-shaped.

4. The electromagnetic transducer as described in claim 2, wherein the first arm of the elastic member is U-shaped, the second arm forms an angle respective with the first arm.

5. The electromagnetic transducer as described in claim 4, wherein the second arm defines a first part attached to the frame, a second part connected with the first arm and a U-shaped root part connected the first part and the second part.

6. The electromagnetic transducer as described in claim 5, wherein the second part of the second arm is adjacent to the first arm and forms a slit therebetween.

7. The electromagnetic transducer as described in claim 6, wherein the stress-releasing portion is disposed on the second part and adjacent to the U-shaped root part.

8. The electromagnetic transducer as described in claim 7, wherein the periphery portion of the diaphragm defines an out fringe attached to the frame and an inner fringe attached to the top plate with the first arm of the elastic member disposed between the inner fringe and the top plate and the first part of the second arm disposed between the outer fringe of the periphery portion and the frame.

9. The electromagnetic transducer as described in claim 8, wherein the elastic member further defines a position plate disposed at the end of the second arm and defining a hole.

10. An electromagnetic transducer, comprising:
a frame;
a vibrating unit including a diaphragm and a voice coil;
a magnetic circuit unit receiving in the frame;
a pair of elastic members assembled with the frame and connected with the vibrating unit, each including a first arm attached to the diaphragm and a pair of second arms extending outwards along a devious way from the first arm and defining a first part attached to the frame, a second part connected with the first arm and a U-shaped root part connected the first part and the second part; wherein
the second part of the second arm defines a stress-releasing portion adjacent to the U-shaped root part.

11. The electromagnetic transducer as described in claim 10, wherein the stress-releasing portion is U-shaped and extend from the second part along a vibrating direction of the vibrating unit away from the diaphragm.

12. The electromagnetic transducer as described in claim 10, wherein the stress-relieving portion is undulate-shaped and protrudes outwards from a plane of the first arm disposed in.

13. The electromagnetic transducer as described in claim 11, wherein the first arm of the elastic member is U-shaped, and the second arms extend from the first arm obliquely.

14. The electromagnetic transducer as described in claim 13, wherein the second part of the second arm is adjacent to the first arm and forms a slit therebetween.

15. The electromagnetic transducer as described in claim 14, wherein the diaphragm defines a top plate and a periphery portion defining an outer fringe attached to the frame and an inner fringe attached to the top plate.

16. The electromagnetic transducer as described in claim 15, wherein the first arm of the elastic member is disposed between the inner fringe of the periphery portion and the top plate, and the first part of the second arm is disposed between the outer fringe of the periphery portion and the frame.

17. An electromagnetic transducer, comprising:
a frame;
a magnetic circuit part accommodated in the frame and including a pair of magnetic gaps;
a vibrating unit including a diaphragm attached to the frame and a pair of voice coils partially inserted into the magnetic gaps for driving the diaphragm;
an elastic member elastically connected to the frame and the diaphragm, including a first end attached to the diaphragm and disposed in a plane, a second end attached to the frame and a mid portion disposed between the first end and the second end and suspended in the frame; wherein
the mid portion further defines a stress-releasing portion and protrudes outwards from the plane.

18. The electromagnetic transducer as described in claim 17, wherein the stress-releasing portion is U-shaped and protrudes away from the diaphragm.

19. The electromagnetic transducer as described in claim 17, wherein the stress-relieving portion is undulate-shaped.

20. The electromagnetic transducer as described in claim 18, wherein the diaphragm defines a top plate and a periphery portion defining an outer fringe attached to the frame and an inner fringe attached to the top plate, the first end of the elastic member is disposed between the inner fringe of the periphery portion and the top plate, the second end of the elastic member is disposed between the outer fringe of the periphery and the frame.
